(19) United States
(12) Patent Application Publication
(10) Pub. No.: US 2010/0110686 A1
(43) Pub. Date: May 6, 2010

(54) LED LIGHT MODULE

(76) Inventors: Tzung-Yang Li, Taipei County (TW); Tzu-Pin Lin, Tai-Nan City (TW); Chien-Lung Tsou, Taoyuan County (TW); Chi-Neng Mo, Tao-Yuan Hsien (TW)

Correspondence Address: NORTH AMERICA INTELLECTUAL PROPERTY CORPORATION, P.O. BOX 506, MERRIFIELD, VA, 22116, US

(21) Appl. No.: 12/364,528

(22) Filed: Feb. 3, 2009

(30) Foreign Application Priority Data
Nov. 6, 2008 (TW) 097142839

(51) Int. Cl. F21V 19/00; F21V 5/04

(52) U.S. Cl. 362/249.06; 362/231; 362/244

(57) ABSTRACT

An LED light module of uniformly mixed light is provided. The LED light module has a plurality of shifted-disposed LED packages, arranged as a polygon, disposed on a substrate. Each of the shifted-disposed LED packages includes a base, and an LED die disposed aside from a center of the base. The light emitted from the shifted-disposed LED package is asymmetrically dispersed and is tilted to a predetermined direction. Therefore, the lights from the shifted-disposed LED packages are centralized and uniformly mixed as white light.

### BACKGROUND OF THE INVENTION

1. Field of the Invention

The present invention is related to an LED light module, and particularly, to an LED light module of white light resulting from a mixture of asymmetric lights.

2. Description of the Prior Art

LED has advantages of high brightness, mercury-free, long life expectancy, and less energy consumption so that LED is considered as one of the light sources in the next generation. LED may be used as the major light source in cell phones, automotive lightings, and outdoor large displays. In addition, LED has characteristics of high saturation and good color reproduction and has potential for replacing CCFL in the back light module.

FIG. 1 and FIG. 2 are schematic diagrams illustrating a conventional bullet-shaped LED package 10. FIG. 1 shows the bullet-shaped LED package 10 in a cross-sectional view, and FIG. 2 shows a top view diagram of the bullet-shaped LED package 10. The bullet-shaped LED package 10 has a lead frame 12, a resin molding 14, and an LED die 16. The lead frame 12 includes a base 121 and two leads 122. The LED die 16 is disposed on the base 121 and electrically connected to the leads 122 through a respective wire 18 for power supply that allows the LED die 16 for radiation. The LED die 16, the base 121, and the front end of the lead 122 are encapsulated by the resin molding 14. As shown in FIG. 1, the front of the resin molding 14 is a sphere surface 141, and the LED die 16 is disposed at the radius of curvature of the sphere surface 141. The lights generated by the LED die 16 are refracted and at the sphere surface 141, and the refracted lights are scattered symmetrically. Additionally, the refracted lights follow the Lambert's cosine law and have a Lambertain light distribution property.

Please refer to FIG. 3. FIG. 3 is a schematic diagram illustrating another conventional back light module 20. The back light module 20 provides white lights by means of mixing lights from a red LED package 22, a green LED package 24, and a blue LED package 26, in which the lights from the red LED package 22, the green LED package 24, and the blue LED package 26 have a Lambertain light distribution property. However, the overlapped region of the lights from the red LED package 22, the green LED package 24, and the blue LED package 26 is limited by the position of the LED packages and the symmetrical distribution of the lights generated by the red LED package 22, the green LED package 24, and the blue LED package 26. It is difficult to overlap the red lights, the blue lights, and the green lights from the respective LED package for providing well mixed white lights.

In order to provide well mixed white lights, a conventional surface mount device (SMD) type LED package 30 is shown in FIG. 4. The SMD type LED package 30 packages a plurality of LED dies, such as two red LED dies 32, 36, a blue LED die 34, and a green LED die 38 in a reflective cup 40. The LED dies are electrically connected to a plurality of wires 42 for power supply. Lights generated by the LED dies 32, 34, 36, and 38 are reflected at the surface of the reflective cup 40 and mixed to result in white lights having Lambertain light distribution property. However, the SMD type LED package 30 have to package several LED dies in the same reflective cup 40 that increases complexity of manufacturing process and production cost. If one of the packaged LED die breaks down, the defective LED die decreases reliability and the yield of the back light module having the SMD type LED package 30. Besides, it is difficult to replace the defective LED die. Therefore, the SMD type LED package 30 is not an ideal light source for back light module.

### SUMMARY OF THE INVENTION

It is therefore a primary objective of the present invention is to solve the problems of uneven mixing light, high production cost, and laborious product maintenance.

According to the present invention, an LED light module capable of providing well mixed lights. The LED light module includes a substrate and a plurality of shifted-disposed LED packages disposed on the substrate, in which the shifted-disposed LED packages are arranged as a polygon. Each of the shifted-disposed LED packages has a base, an LED die disposed aside from a center of the base in a predetermined distance.

The LED light module of the present invention uses the shifted-disposed LED packages as its light source. Lights generated by the shifted-disposed LED packages are distributed asymmetrically and are refracted in a particular direction. Accordingly, lights of different colors are overlapped in a predetermined region and resulted in well mixed white light.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 and FIG. 2 are schematic diagrams illustrating a conventional bullet-shaped LED package.

FIG. 3 is a schematic diagram illustrating another conventional back light module.

FIG. 4 is a schematic diagram illustrating a conventional surface mount device (SMD) type LED package.

FIG. 5 through FIG. 9 are schematic diagrams illustrating an LED light module according to a preferred embodiment of the present invention.

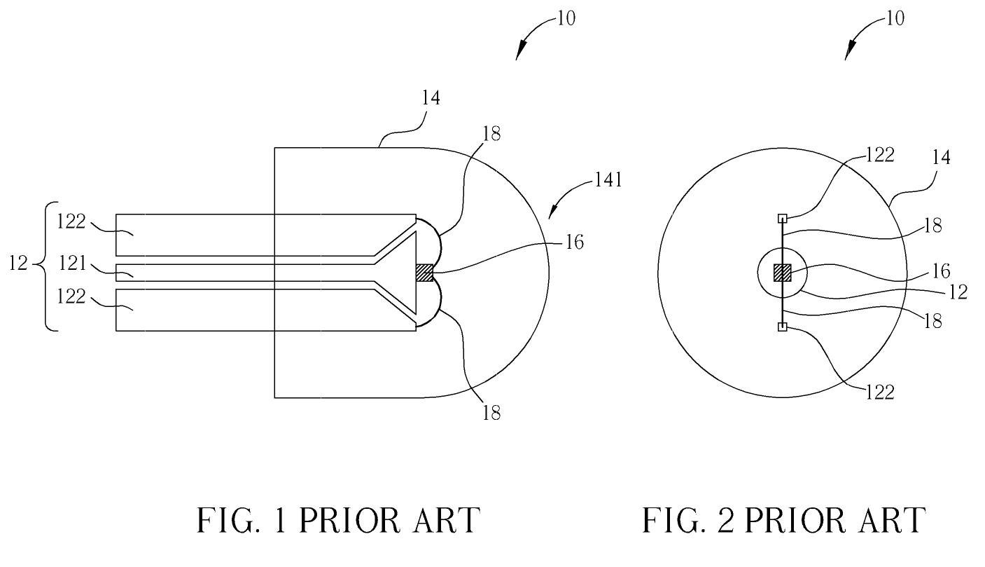

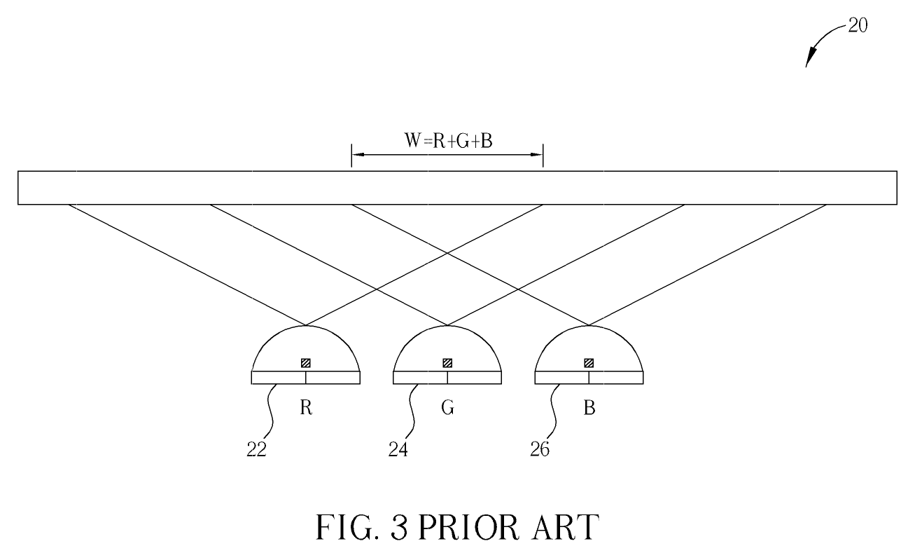

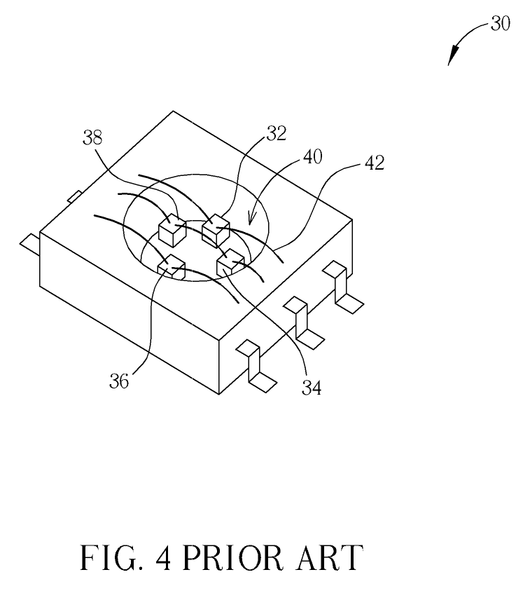

### DETAILED DESCRIPTION

In the following detailed description, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

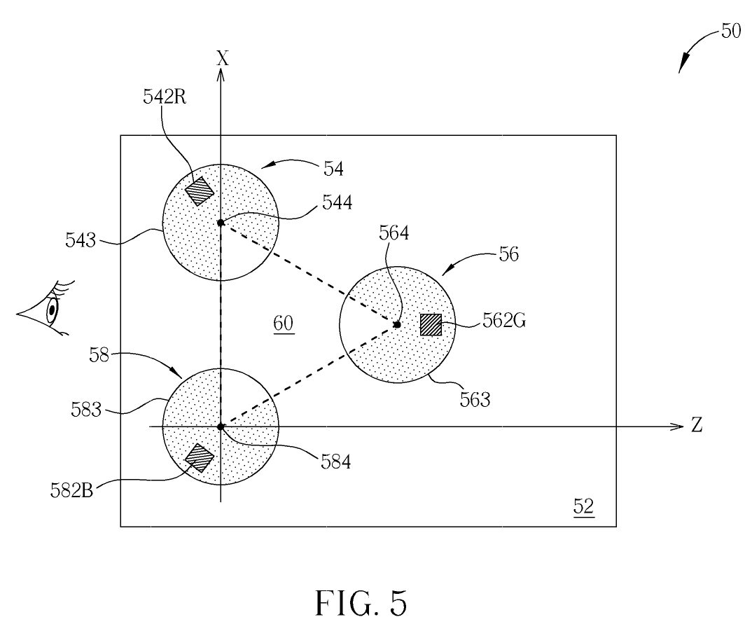

Please refer to FIG. 5 through FIG. 9. FIG. 5 through FIG. 9 are schematic diagrams illustrating an LED light module 50 according to a preferred embodiment of the present invention. As shown in FIG. 5, the LED light module 50 has a substrate 52 and a plurality of shifted-disposed LED packages disposed on the substrate 52. For example, the shifted-disposed LED packages of the present preferred embodiment include a red shifted-disposed LED package 54, a green shifted-disposed LED package 56, and a blue shifted-disposed LED package 58. Red lights from the red shifted-disposed LED package 54, green lights from the green shifted-disposed LED package 56, and the blue lights from blue shifted-disposed LED package 58 are overlapped and resulted in well mixed white lights, and accordingly, the LED light module 50 is capable of providing well mixed white lights. The substrate 52 may be a single-layered or a multi-layered circuit board for electrical connection of the shifted-disposed LED packages or electrical connection among the shifted-disposed LED packages, other devices on the substrate, and devices for power supply. Furthermore, a reflective layer (not shown) is preferably disposed on the substrate 52 for improving light emitting efficiency of the LED light module 50.

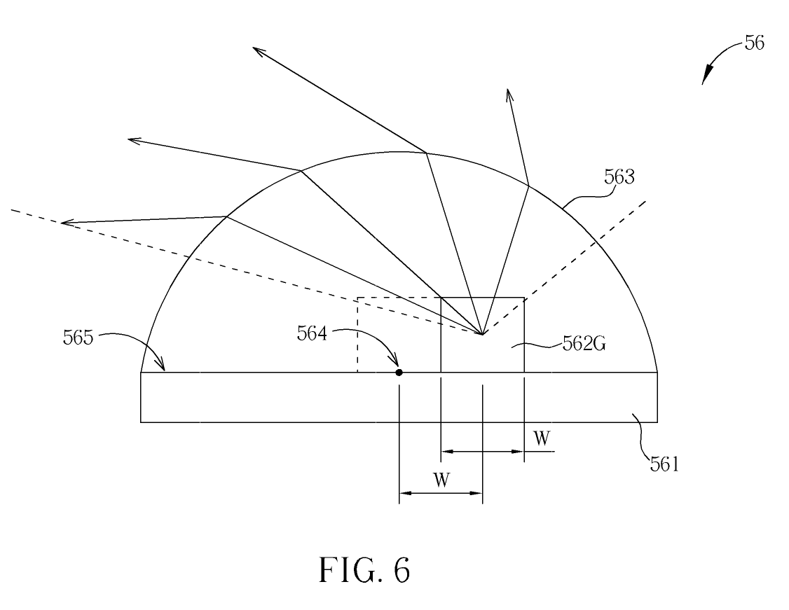

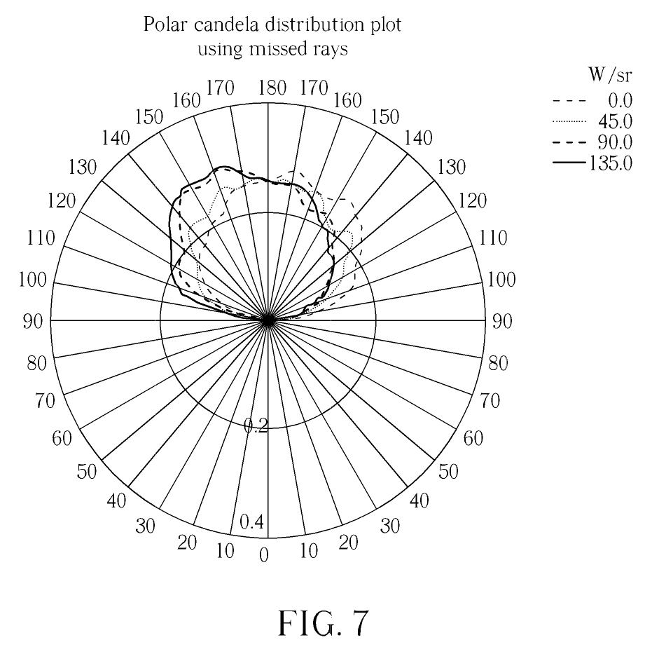

Please refer to FIG. 5 in company with FIG. 6 and FIG. 7. FIG. 6 shows the structure of the green shifted-disposed LED package 56 as an example to illustrate the structures of the shifted-disposed LED packages of the present invention. FIG. 7 shows a polar coordinate representation of the angular distribution of light intensity of shifted-disposed LED packages of the present invention. As shown in FIG. 6, the green shifted-disposed LED package 56 has a base 561, a green LED die 562G, and a lens 563. The base 561 includes a center 564. Any line passing through the center 564 divides the base 561 into two equal parts. The preferable base 561 is a plane and has a reflective layer (not shown) disposed thereon. The green LED die 562G is disposed on a top surface 565 of the base 561, and is electrically connected to the base 561, the substrate 52, and other circuits through wires (not shown) or other electrical connections. The green LED die 562 may be a flip-chip disposed on the base 561. The green shifted-disposed LED package 56 is packaged by a packaging material, such as epoxy, organic resin, transparent ceramic material, transparent glass material, transparent insulating material, or combinations thereof, to encapsulate the green LED die 562G and the base 561 for protection and to form a lens 563 of a cambered surface disposed on the light exiting surface of the green LED die 562G. The cambered surface of the lens 563 may have an arc surface of a sphere or a spheroid. Lights from the green LED die 562G are refracted and dispersed at the surface of the lens 563.

As shown in FIG. 6, the green LED die 562G of the present invention is not disposed on the center 564 of the base 561 and is not overlapped with the center 564 of the base. The green LED die 562 is shifted from the center 564 to a position aside from the center 564 in a predetermined distance. For example, the preferable predetermined distance between the center of the green LED die 562G and the center 564 of the base 561 is equal to the width (W) of the green LED die 562G. The green LED die 562G is not disposed on the center 564 of the base 561 or at the radius of curvature of the lens 56. The green LED die 562G is disposed aside from the center 564 of the base 561. Therefore, the green shifted-disposed LED package 56 is defined as a shifted-disposed LED package. Lights generated by the green LED die 562G are refracted at the lens 563 and are tilted to a predetermined direction. As shown in FIG. 6, the green LED die 562G is positioned at the right side of the center 564. Lights generated by the green LED die 562G pass through the lens 563 and tilt to the left side of the center 564 opposite to the position of the green LED die 562G. And accordingly, lights generated by the shifted-disposed LED package are asymmetrically dispersed and have a non-Lambertain light distribution property.

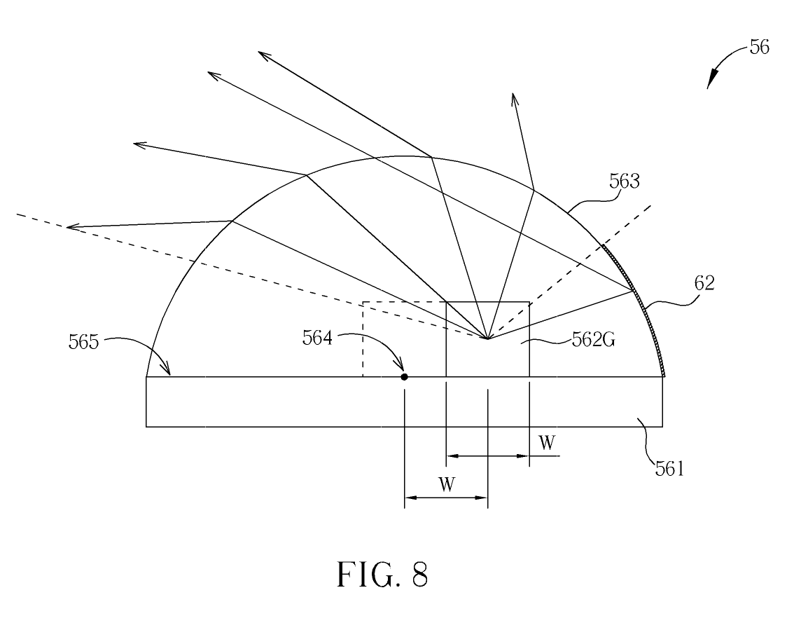

The above description of the shifted-disposed LED packages uses the green shifted-disposed LED package 56 as an example. Both of the red shifted-disposed LED package 54 and blue shifted-disposed LED package 58 have similar structures as the green shifted-disposed LED package 56. For the sake of describing the present invention in an easier way, the center 564 of the base 561 of the present preferred embodiment is overlapped with the radius of curvature of the lens 563. The area of the base 561 is equal to the area of the cross-section passing through the radius of curvature of the lens 56. However, the present invention is not limited to the above-mentioned preferred embodiment. The center of the base may be vertically positioned at a point on or above the radius of curvature of the lens. The center of the base may be positioned at a point on the left side or on the right side of the radius of curvature of the lens. The size of the base may be larger than or smaller than the cross-section of the lens 56. Please refer to FIG. 8. A thin film 62 of good reflective property or a refractive index smaller than the lens 563 may be formed on a portion of the surface of the lens 563. Lights against the center 564 striking at the thin film 62 are reflected that are gathered in the overlapped region for mixing lights to increase light extraction efficiency of the LED die 562G.

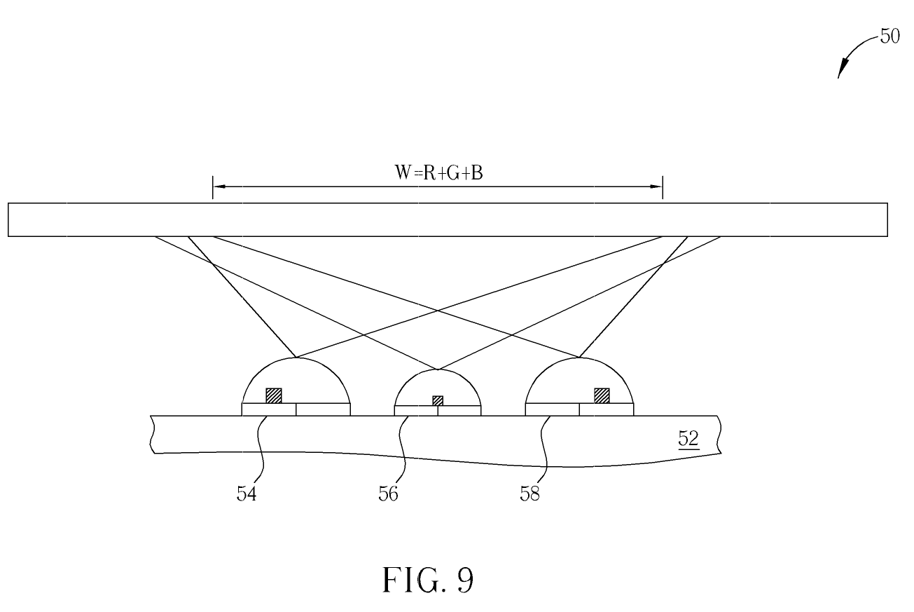

Please refer to FIG. 5 in company with FIG. 9. FIG. 9 is a schematic diagram showing the LED light module 50 along the Z-axis in FIG. 5. As shown in FIG. 5, the red shifted-disposed LED package 54, green shifted-disposed LED package 56 and blue shifted-disposed LED package 58 are arranged as a triangle, and the distance between any two of the shifted-disposed LED packages is of equal length. The shifted-disposed LED packages may not be limited to be arranged as an equilateral triangle. The position of the shifted-disposed LED packages may be determined depending on the illumination region of the tilted lights generated by the shifted-disposed LED packages. The centers 544, 564, 584 of the respective shifted-disposed LED packages are positioned at vertices of the triangle and the sides of the triangle define an area of the triangle 60. It should be noted that the red LED die 542R of the red shifted-disposed LED package 54, the green LED die 562G of the green shifted-disposed LED package 56, and the blue LED die 582B of the blue shifted-disposed LED package 58 are positioned out of the area of the triangle 60. In addition, the red LED die 542R, the green LED die 562G, and the blue LED die 582B are disposed in the projection area of the respective lens 543, 563, 583. (In other words, the red LED die 542R, the green LED die 562G, and the blue LED die 582B may be disposed in the shadowed area of FIG. 5.) Please refer to FIG. 9. Since lights generated by the shifted-disposed LED packages of the present invention are asymmetrically dispersed, these lights are tilted against to the direction of the respective LED die shifted from the center of the respective base. Therefore, lights generated by the red shifted-disposed LED package 54, the green shifted-disposed LED package 56, and the blue shifted-disposed LED package 58 are gathered in the overlapped region above the area of the triangle 60, and the overlapped lights are mixed into white light of uniformity.

As described above, the present invention uses shifted-disposed LED packages as its light source, and the LED dies disposed therein are disposed out of the area of the triangle defined by the centers of the bases. The LED dies and the respective centers of the base are disposed in a predetermined length. Lights generated by the shifted-disposed LED package are asymmetrically dispersed, and are tilted to a predetermined direction opposite to the direction which the LED dies shifted from the center of the base. The position of the shifted-disposed LED packages improves the usability of the red light, the green light and the blue light generated by the shifted-disposed LED packages, in which the red light, the green light, and the blue light are gathered in the overlapped region in a maximal level and mixed into white lights of uniformity. The above-mentioned preferred embodiment provides white lights by means of overlapping red light, green light, and blue light. Other combinations of color lights are allowable. For example, combination of yellow light and blue light, combination of magenta light and green light, or combination of cyan light and red light are allowable for the present invention. Furthermore, the position and the number of the shifted-disposed LED packages may be modified depending on the color of the light sources. The shifted-disposed LED packages may be arranged as a rectangular, a pentagon, a hexagon, or a polygon as required.

Those skilled in the art will readily observe that numerous modifications and alterations of the device and method may be made while retaining the teachings of the invention.

What is claimed is:

1. AN LED light module, comprising:
a substrate; and
a plurality of shifted-disposed LED packages disposed on the substrate, the shifted-disposed LED packages arranged as a polygon, and each of the shifted-disposed LED packages comprising:
a base having a center thereof; and
an LED die disposed aside from the center of the base in a predetermined distance.

2. The LED light module of claim 1, wherein the shifted-disposed LED package further comprises a lens covering the LED die and the base.

3. The LED light module of claim 1, wherein the shifted-disposed LED packages comprises a red shifted-disposed LED package, a green shifted-disposed LED package, a blue shifted-disposed LED package, or combinations thereof.

4. The LED light module of claim 1, wherein the centers of the respective base are vertices of the polygon, and the LED dies are located out of the area of the polygon defined by the vertices.

5. The LED light module of claim 1, wherein the predetermined distance is equal to a width of the LED die.

6. The LED light module of claim 5, wherein the polygon is a triangle.

7. The LED light module of claim 6, wherein the triangle is an equilateral triangle.

8. The LED light module of claim 6, wherein the distance between any two of the shifted-disposed LED packages is of equal length.

9. The LED light module of claim 1, wherein light generated by the shifted-disposed LED packages are non-Lambertain light.
